(19) United States
(12) Patent Application Publication
(10) Pub. No.: US 2008/0032032 A1
(43) Pub. Date: Feb. 7, 2008

(54) CHERRY-BASED ADDITIVE

(76) Inventor: Raymond M. Pleva, Cedar, MI (US)

Correspondence Address: MCGARRY BAIR PC, 32 Market Ave. SW, SUITE 500, GRAND RAPIDS, MI, 49503, US

(21) Appl. No.: 11/461,563

(22) Filed: Aug. 1, 2006

(51) Int. Cl. A23L 1/31

(52) U.S. Cl. 426/615; 426/641

(57) ABSTRACT

A cherry based additive is a stable powder comprising a mixture of cherry powder, fiber and gum. The cherry powder is made from a cherry puree. A marinade comprises water, phosphate, salt and about 6% by weight cherry concentrate made from the puree or from the cherry powder.

### BACKGROUND OF THE INVENTION

1. Field of the Invention

The present invention relates to an additive to foods, nutraceuticals, and topically applied products that provides many benefits using all natural ingredients.

2. Description of the Related Art

Consumption of cherries and its products are known to provide a variety of health benefits. Tart cherries (prunus cerasus), especially the Montmorency and Balaton varieties, have been shown to be a particularly good source of bioflavonoids in addition to anti-oxidants. For example, anthocyanins from cherries are known to be an effective anti-inflammatory agent. Melatonins from cherries are known to be an effective anti-oxidant. Both have been found to reduce cancers. Cherries are also believed to assist in the proper balancing of certain hormones. Indeed, cherries are commonly called “the healing fruit.”

It is known to extract components from cherries and utilize them in other compositions such as food additives and supplements. For example, flavonoids have been extracted from tart cherries and incorporated into foods. It is also known to combine alpha-hydroxy acids with emu oil to provide moisturizing creams and lotions. Cherries are known to be a source of malic acid which is a type of alpha-hydroxy acid. Also, it is known to combine pitted tart cherries with comminuted meat to increase moisture, reduce fat content, and improve flavor, and it is further known to use cherry compounds to cure certain types of meat. See, for example, commonly owned U.S. Pat. No. 5,652,007, and Canadian Patent No. 1,335,244. It has been proposed to enhance the flavor of food by processing Montmorency cherries into a puree and using it as an additive to prepared foods. See for example, U.S. Pat. No. 4,752,495.

There remains a need to provide cherries as an additive at low cost and in a manner that is easy to use, stable, with a longer shelf life, and easily transportable.

### SUMMARY OF THE INVENTION

A cherry-based additive according to the invention comprises a mixture of water, phosphates, salt and an effective amount by weight of cherry concentrate. Preferably, the amount is about 6% by weight of mixture.

In one aspect of the invention, a process of preparing meat prior to cooking comprises providing uncooked meat, and applying a marinade comprising a mixture of water, phosphate, salt and about 6% by weight cherry concentrate.

In another aspect of the invention, a method of making cherry powder comprises the steps of providing raw cherries; making a cherry concentrate from the raw cherries at a concentration of about 68 brix; spray drying the cherry concentrate to form flakes; grinding the flakes to form a powder; and adding fiber and gum to the powder. The invention also includes a cherry powder formed by the foregoing method.

In a further aspect, a food additive comprises a mixture, by weight, of about 30% cherry powder, 46% maltodextrin, and 24% corn starch.

### BRIEF DESCRIPTION OF DRAWING

FIG. 1 is a flow chart showing a process of making a cherry additive according to the invention.

FIG. 2 is a flow chart showing one embodiment of a process for making a dry additive.

FIG. 3 is a flow chart showing a second embodiment of a process for making a dry additive.

### DETAILED DESCRIPTION

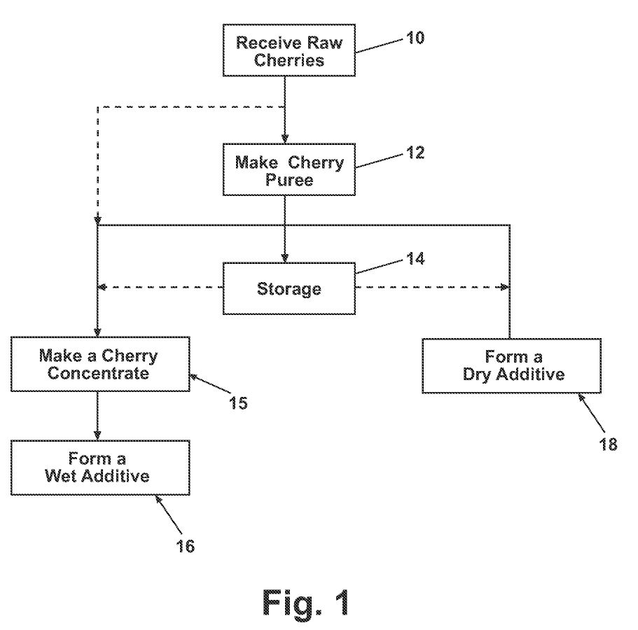

The present invention relates to an all natural cherry-based additive. Looking at FIG. 1, the process of making a cherry additive according to the invention begins at 10 with receiving raw cherries from a grower or other source and manufacturing a cherry puree at 12.

For the receiving step 10, tart (or sour) cherries will preferably be used. The most abundant variety of tart cherries commercially available today is Montmorency, although another common variety is Balaton. Sweet cherries can also be used, but it will be understood that the variety of cherries selected affects primarily the amount needed to achieve the desired flavor enhancement and the health benefits to be effected by the compounds contributed by the respective varieties. The cherries can be fresh or individually quick frozen (IQF). They will have been inspected, sorted, washed, and pitted using conventional methods.

The cherry puree 12 is preferably made using any well-known process. The cherry puree 12 can be stored for further use 14, used in forming a wet additive 16, or used in a process for forming a dry additive 18. If stored for further use, the cherry puree 12 is preferably frozen.

For making a wet additive 16, the cherry puree 12 is first made into a cherry concentrate 15. The cherry concentrate 15 can be made by cooking down the puree 12, or cooking down IQF cherries previously ground into a puree, or by squeezing and cooking down whole cherries, preferably to a concentration of 68 brix. The term “brix” is used in its conventional meaning of a unit of measure of sucrose (the percent of sugar in 100 g of cane sugar solution). A concentration greater or lesser than 68 brix is acceptable, preferably within a range of plus or minus seven brix. Using Montmorency cherries, it takes about 88 lbs. of cherries to render 1 gallon of cherry concentrate at about 68 brix. Cherry concentrates within the preferred range of concentration are commercially available.

In one aspect of use with a wet additive, the cherry concentrate 15 can be used to form a meat marinade. In one embodiment, a marinade according to the invention was prepared by combining 1.25 lbs. of cherry concentrate, 1 lb. of salt, 0.5 lbs. of phosphate, and 17.25 lbs. of water. 100 lbs. of chicken breast is introduced into the marinade and allowed to tumble therein for 30 minutes. After tumbling, the chicken is refrigerated overnight, and the following day the chicken is baked in a convection oven until an internal temperature of 180° F. is achieved. Considerable enhancement of texture and flavor was noted.

In another example, a marinade according to the invention was prepared by combining 0.91 lbs. of cherry concentrate, 1 lb. of salt, 0.5 lbs. of phosphate, and 12.6 lbs. of water. The marinade is then injected at a 15% injection rate into 100 lbs. of pork loins. Thereafter, the loins are introduced into a tumbler and tumbled for 30 minutes. After tumbling, the loins are refrigerated overnight. The following day, the treated loins are baked in a convection oven until an internal temperature 180° F. is achieved. Again, considerable enhancement of texture and flavor was noted.

The marinade can be applied as described herein to any fish or meat. The term “meat” as used herein includes chicken, beef, pork, lamb, turkey, buffalo, or game of any quality. It will be understood that the meat can be cooked alone or in combination with any other foot food product, but the marinade will preferably be applied to the meat prior to cooking.

The marinade can be applied by any known method, including tumbling, injection, spraying, rubbing, soaking, or comminuting in a blender or mixer. The meat cuts can be in any form, such as a whole muscle pieces, slices, diced, or comminuted. The marinade, according to the invention, comprises four basic components: water, phosphate, salt, and an effective amount of cherry concentrate 15, the critical component being the cherry concentrate. Preferably the amount of cherry concentrate 15 is about 6% by weight in the mixture.

It is believed that the most beneficial aspects of the marinade come from the cherry skins, so it is preferred that the cherry product utilized in making the marinade be derived from whole cherries, including the skins. It is apparent that, unlike other marinades, there is no cooking or heating of the preparation before use, other than any required preparation for the cherry concentrate. Moreover, it is believed that the use of phosphates is optional. In addition, other flavorings can be added as desired. It will be understood that the marinade according to the invention does not change the flavor of the meats to which it is applied and no “cherry taste” is apparent upon use. The marinade enhances the flavor of the meat itself, and has been found to make the meat more tender, more digestible, eliminate aftertaste, neutralize sodium tastes, and extend shelf life.

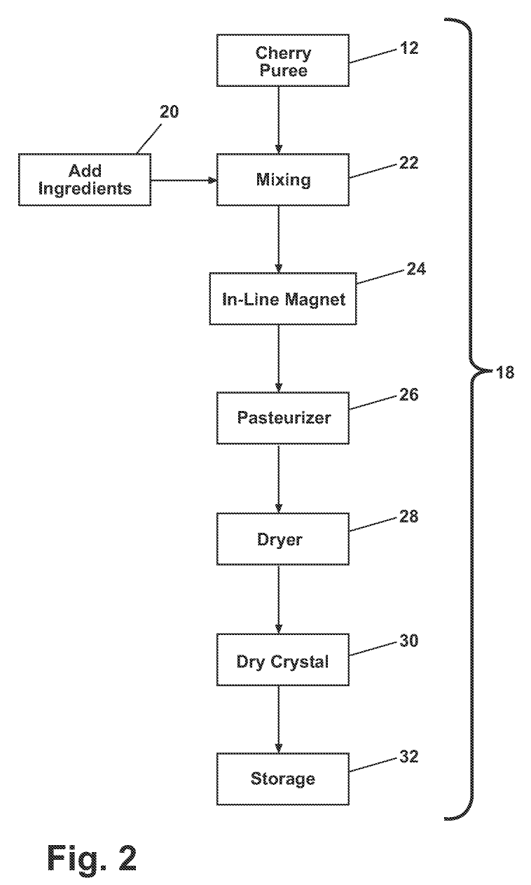

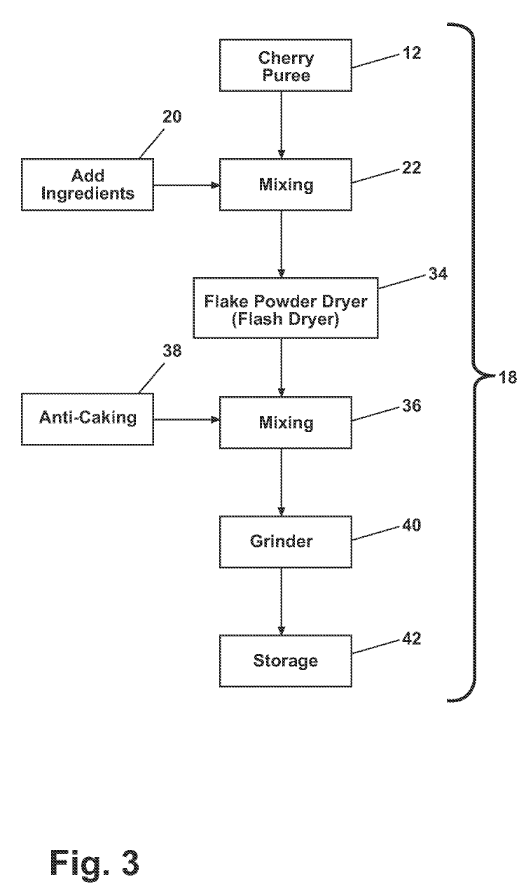

Exemplary uses in a process for forming a dry additive 18 are shown in FIGS. 2 and 3. The cherry puree 12 can be formed into a powder using a variety of techniques, such as freeze drying, flash drying, spray drying and the like.

Looking at a first embodiment in FIG. 2, a freeze drying process is shown. The cherry puree 12 is delivered to a mixing station 22 where additional ingredients 20 can be added. Those ingredients can be wet or dry, and typically include such ingredients as maltodextrin, lecithin, carboxymethylcellulose (CMC), anti-caking compounds, desiccants, etc. The resulting mixture is passed through an inline magnet at 24, and pasteurized 26. It enters a vacuum freeze dryer at 28 and exits as dry crystals at 30. The resulting crystals are preferably sized to pass through a #10 ASTM filter with a maximum moisture content of 2.5%. Ideally, it will contain at least 60% red sour cherry solids and puree. It can be stored in a cool, dry area at a temperature not exceeding 70° F., or for long term storage at a temperature not exceeding 45° F.

Looking now at FIG. 3, another embodiment of a flash drying process is shown. The cherry puree 12 is delivered to a mixing station 22 where additional ingredients 20 can be added. Here, cranberry fiber, maltodextrin, CMC, and lecithin are added. The mixture then enters a flash dryer at 34, where it is dried into flakes. The flakes then enter into another mixing station at 36 where an anti-caking ingredient is added. Preferably, the anti-caking ingredient is calcium strearate. The resultant mixture can be frozen overnight to provide additional moisture removal. It then enters a grinder at 40, where the flakes are ground into a powder and then stored 42. One formula comprises by weight, 80% cherry powder, 6% cherry concentrate and cranberry fiber, 12% V maltodextrin, 1.25% CMC and lecithin, and 0.75% calcium strearate. In another aspect, the cherry powder can be combined with other fruit fibers and a gum to stabilize it. Another preferable composition is 95.5% cherry powder, 4% cranberry fiber and 0.5% gum by weight. Color can be adjusted by adding apple powder in varying proportions. Preferably, any fruit composition having a high fiber content and/or a high antioxidant level can be used with the cherry powder. At this point, the powder is shelf stable and can be packaged for shipment or further storage.

In another formula for the cherry powder as a food additive, it can be mixed with additional maltodextrin and corn starch in the following proportions by weight: 30% cherry powder, 46% maltodextrin, and 24% corn starch. As well the cherry powder can be substituted for the cherry concentrate in a marinade to comprise the following proportions: 0.9-1.25 lbs. of cherry powder, 1 lb. of salt, 0.5 lbs. of phosphate, and 12-6-17.25 lbs. of water.

In all forms, the moisture content of the resulting food additive will preferably be about 2-4% and the powder is completely soluble in water, fat, and oil. The food additive can be used with fresh frozen foods, and it can also be used in curing hams, bacon and other meats. It finds use in marinades and breading for meat products. The cherry powder can also be used as an additive to nutraceuticals and topically applied products that are absorbed into the skin. For example, it can be combined with emu oils as disclosed in WO2006015119, the entirety of which is incorporated herein by reference.

While the invention has been specifically described in connection with certain specific embodiments thereof, it is to be understood that this is by way of illustration and not of limitation, and the scope of the appended claims should be construed as broadly as the prior art will permit.

What is claimed is:

1. A food additive comprising a mixture of water, phosphate, salt and about 6% by weight cherry concentrate having a concentration of about 68 brix.

2. A process of preparing meat prior to cooking comprising:
providing uncooked meat, and
applying a marinade comprising a mixture of water, phosphate, salt and about 6% by weight cherry concentrate having a concentration of about 68 brix.

3. A method of making cherry powder comprising the steps of:
providing raw cherries;
making a cherry puree from the raw cherries;
adding ingredients selected from a group consisting of maltodextrin, CMC, lecithin, gum, and fruit fiber,
drying the cherry concentrate to form a powder; and
storing the powder for further use as a food additive.

4. The method of claim 3 wherein the drying step comprises vacuum freeze drying.

5. The method of claim 3 wherein the drying step comprises flash drying.

6. A cherry powder formed by the method of claim 3.

7. A food additive comprising a mixture, by weight, of about 30% cherry powder, 46% maltodextrin, and 24% corn starch.

8. A food additive in the form of a powder comprising a mixture, by weight, of about 80% cherry powder, 6% cherry concentrate and cranberry fiber, 12% maltodextrin, and 2% CMC, lecithin and calcium stearate.
